(19) United States
(12) Patent Application Publication
(10) Pub. No.: US 2005/0112525 A1
(43) Pub. Date: May 26, 2005

(54) Dental apparatus with ozone irrigation system

(76) Inventors: Roger McPherson, Calgary (CA); Patrick Johnson, Cowan Heights, CA (US); Stephen F. Schwartz, Houston, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/956,478

(22) Filed: Oct. 1, 2004

Related U.S. Application Data
(60) Provisional application No. 60/508,678, filed on Oct. 2, 2003.

(51) Int. Cl. A61C 5/02

(52) U.S. Cl. 433/81; 433/224

(57) ABSTRACT

A dental apparatus is provided with an ozone irrigation system. Ozonated water is produced in the irrigation system and supplied to the dental apparatus. The dental apparatus can have a handpiece that drives a cannulated instrument, such as a cannulated file. The ozonated water can be supplied to an axial passage formed in the instrument. Radial ports are provided through the instrument such that the ozonated water can spray radially outward into a treatment zone during movement of the instrument. The ozonated water thereby can lubricate and cool the treatment zone while also providing advantageous cleaning of the zone.

### RELATED APPLICATIONS

This application claims the priority benefit pursuant to 35 U.S.C. § 119(e) of U.S. Provisional Patent Application No. 60/508,678, filed on Oct. 2, 2003, which is hereby incorporated by reference in its entirety.

### BACKGROUND OF THE INVENTION

1. Field of the Invention

The present invention generally relates to dental equipment. More particularly, the present invention relates to dental equipment used to apply ozonated water at a repair site of a patient's tooth, including dental equipment that incorporate or use a cannulated file.

2. Description of the Related Art

Endodontics or root canal therapy is a procedure in which the crown of a diseased tooth is opened to provide access to the root canal of the tooth. The root canal is then cleaned by any of a variety of techniques. Typically, the canal is cleaned with a rotary file. The file typically possesses contoured or roughened outer surfaces to enable the user to breakup and loosen tissues as well as to remove infected dentin from the canal walls within the root canal.

Once the canal has been shaped and cleaned, a bactericidal agent is introduced into the root canal to disinfect the root canal. The goal of this step is to eliminate as much bacteria as possible. After the shaping, cleaning and disinfecting has been completed, the root canal is obturated or filled and the crown of the tooth is repaired.

During the cleaning and shaping, if the file is motor driven, it has been found that the relatively higher rotational speeds coupled with a difficulty to adequately lubricate the file at the points of contact with the canal wall can create a smear layer along at least a portion of the canal wall. The smear layer acts to prevent healing agents or bactericidal agents from entering all of the tubules contained within the tooth. Thus, the tooth is not cleaned as well as it could be prior to the end of the root canal procedure. Such a partial cleaning is not desired and improvements are needed.

### SUMMARY OF THE INVENTION

Accordingly, a system has been developed whereby an ozonated water lubricant can be supplied through the file and introduced at the base of the root canal or at the base of the zone in which the file is operating. The ozonated water has beneficial bactericidal properties and the introduction through the file allows the file and canal wall interface to be better lubricated. Accordingly, it is less likely that an extensive smear layer will develop and it is more likely the more bacteria can be killed prior to completion of the root canal.

An aspect of the present invention involves a dental apparatus that comprises a handpiece and an ozonated irrigant supply system. The ozonated irrigant supply system comprises a dry air source and an ozone generator. A pump is connected to the dry air source and the ozone generator and is adapted to supply air from the dry air source to the ozone generator. An ozone mixing chamber is connected to the ozone generator. The ozone mixing chamber also is connected to a water source. The ozone mixing chamber introduces ozone produced by the ozone generator to the water drawn from the water source to produce ozonated water. An ozonated water supply pump is fluidly connected to the ozone mixing chamber and the ozonated water supply pump is fluidly connected to the handpiece. The handpiece drives a cannulated instrument that comprises an axial flow passage. The ozonated water supply pump supplies ozonated water to the axial flow passage.

### BRIEF DESCRIPTION OF THE DRAWINGS

These and other features, aspects and advantages of the present invention will now be described with reference to the drawings of one or more preferred embodiment. The illustrated embodiments are intended to illustrate and not to limit the invention. The drawings comprise the figures described below.

FIG. 1 is a schematic illustration of an ozonated water supply system and an associated dental apparatus.

FIG. 2 is a schematic illustration of another ozonated water supply system and an associated dental apparatus.

FIG. 3 is an enlarged view of a portion of a dental handpiece.

FIGS. 4 and 5 are greatly enlarged partial views of an instrument that is arranged and configured in accordance with certain features, aspects and advantages of the present invention.

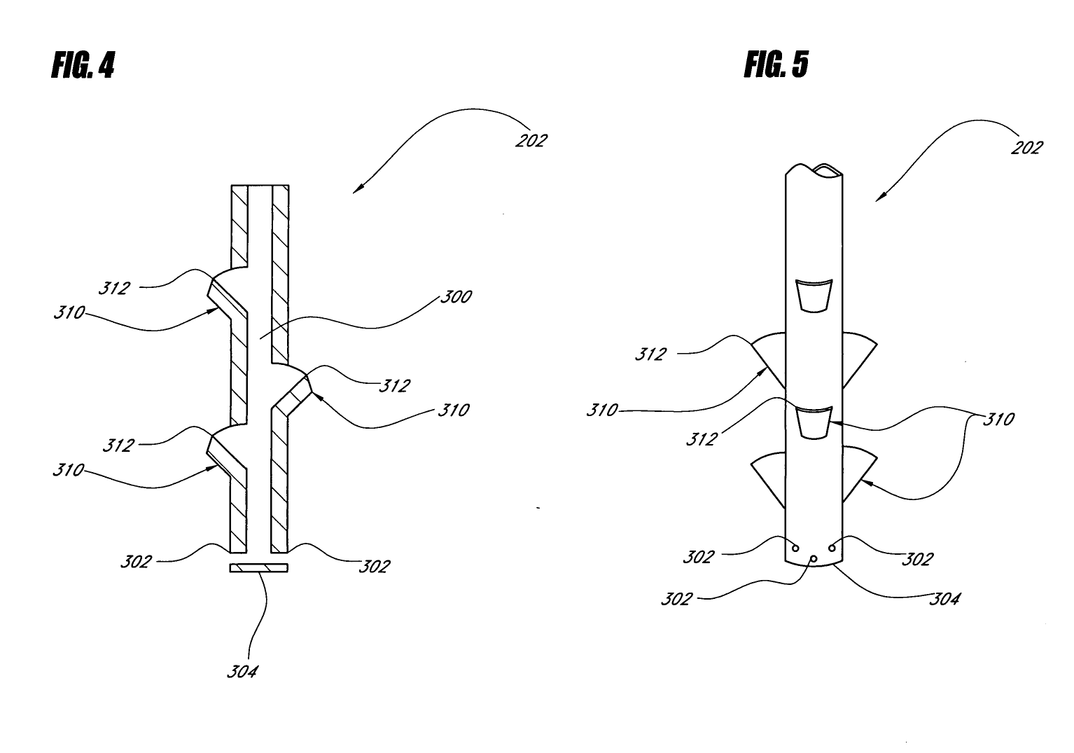

### DETAILED DESCRIPTION OF THE PREFERRED EMBODIMENTS

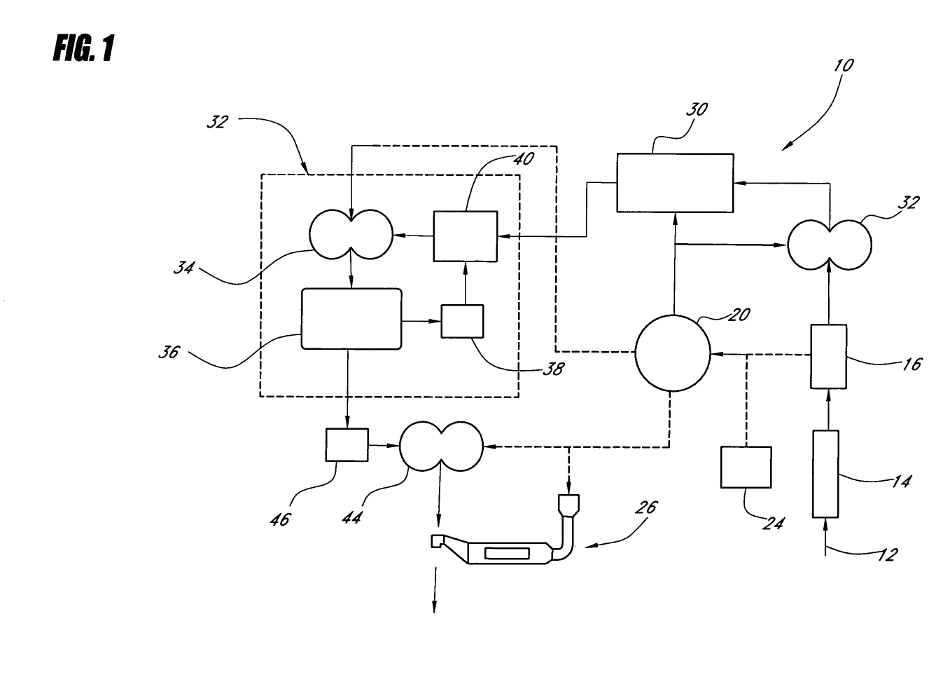

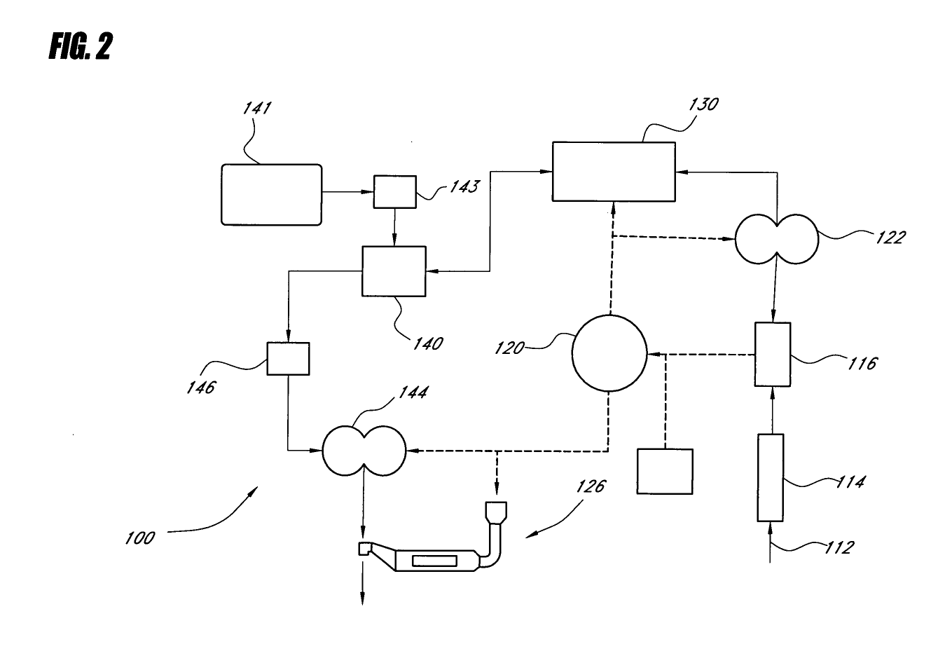

With reference to FIGS. 1 and 2, two systems are illustrated in which ozonated water is produced and delivered to a dental apparatus. The dental apparatus, as will be described below, preferably comprises a handpiece and an associated instrument, such as a file. In one particularly advantageous arrangement, the instrument is a cannulated file that can be used during the performance of a root canal procedure or the like.

With reference now to FIG. 1, a first system 10 provides a ready-to-use ozonated water source. As illustrated, air is introduced into the system through an inlet 12. The air flows through an air drying arrangement 14. The illustrated embodiment features a desiccant that can be used to dry the air. Other arrangements can feature an electric dryer. In some arrangements, the air can be provided by an oxygen generator or from a source of bottled oxygen. Each of the arrangements constitutes means for supplying dry air to the system 10.

The air flow into the system 10 from the air source is monitored by a flow sensor 16. In some arrangements, the volume of air flow is detected while, in other arrangements, the velocity of air flow is detected. In either arrangement, the amount of air flow entering the system 10 can be monitored.

A controller 20 receives an input from the air flow sensor 16 representative of the sensed flow rate. The controller 20 can be a dedicated processor or can be associated with a central processing unit of another system, for instance. Any suitable controller 20 can be used. The input from the sensor 16 can be used by the controller 20 to control operation of a pump 22. The pump 22 draws the air in from the inlet 12 for use by the system 10.

The flow rate of air drawn by the pump 22 can be controlled based upon the supply requirements being experienced by the system 10, which, in part, can be indicated by operator demand. Information regarding operator demand can be provided by a foot pedal 24 or any other suitable manner. The foot pedal 24 can be associated with a dental apparatus 26 and can be used to operate the dental apparatus 26 in any suitable manner.

The air drawn by the pump 22 is supplied to an ozone generator 30. The ozone generator 30 can be of any suitable construction. In one arrangement, the ozone generator 30 functions with the corona discharge principal. The controller 20 preferably controls the ozone generator 30 to supply a desired level of ozone.

The ozone generated by the ozone generator 30 is provided to a recirculating ozonated water supply 32. After a predetermined mixing time, the water becomes sufficiently ozonated for use and can be supplied to the dental apparatus 26 upon demand from the user. The supply 32 preferably comprises a circulating pump 34, an ozonated water reservoir 36, a water filter 38 and a mixing chamber 40. The pump 34 circulates the water through the reservoir 36, the filter 38 and the mixing chamber 40. The mixing chamber receives ozone from the ozone generator 30 and bubbles the ozone into the water supply prior to the pump 34 returning the circulating water to the reservoir 36. The ozone can be mixed by venturi, by diffuser or any other suitable arrangement. Advantageously, the filter 38 removes impurities from the water prior to the water being introduced or reintroduced into the mixing chamber 40. The pump can be controlled by the controller 20 to control how frequently the water returns to the mixing chamber 40, thereby controlling the level of ozone contained within the water held in the reservoir 36.

Water from the supply 32, more particularly the reservoir 36 in the illustrated arrangement, is supplied to the apparatus 26 by a pump 44. Preferably, the water passes through a filtration unit 46 prior to be received by the apparatus 26 and more preferably the water passes through the filtration unit 46 prior to passing through the pump 44. The pump can be a peristaltic pump or any other suitable pump. In the illustrated arrangement, both the apparatus 26 and the pump 44 are controlled by the controller 20. Thus, the flow rate of the ozonated water to the apparatus 26 can be regulated to a desired flow rate, dependent upon the application.

With reference now to FIG. 2, a second system 100 is illustrated that provides ozonated water that is mixed on demand. Thus, ozonated water is not necessarily held in a recirculating arrangement but is produced and supplied according to the immediate needs of a user.

As illustrated, air is introduced into the system 100 through an inlet 112. The air flows through an air drying arrangement 114. The illustrated embodiment features a desiccant that can be used to dry the air. Other arrangements can feature an electric dryer. In some arrangements, the air can be provided by an oxygen generator or from a source of bottled oxygen such that drying is no longer needed. All of these arrangements constitute means for supplying dry air to the system 100.

The air flow into the system 100 from the air source is monitored by a flow sensor 116. In some arrangements, the volume of air flow is detected while, in other arrangements, the velocity of air flow is detected. Other suitable techniques of monitoring air flow can be used. In any arrangement, the amount of air flow entering the system 100 can be monitored.

A controller 120 receives an input from the air flow sensor 116 representative of the sensed flow rate. The controller 120 can be a dedicated processor or can be associated with a central processing unit of another system, for instance. Any suitable controller 120 can be used. The input from the sensor 116 can be used by the controller 120 to control operation of a pump 122. The pump 122 draws the air in from the inlet 112 for use by the system 100.

The flow rate of air drawn by the pump 122 can be controlled based upon the supply requirements being experienced by the system 100, which, in part, can be indicated by operator demand. Information regarding operator demand can be provided by a foot pedal 124 or any other suitable manner. The foot pedal 124 can be associated with a dental apparatus 126 and can be used to operate the dental apparatus 126 in any suitable manner.

The air drawn by the pump 2 is supplied to an ozone generator 130. The ozone generator 130 can be of any suitable construction. In one arrangement, the ozone generator 130 functions on the corona discharge principal. The controller 120 preferably controls the ozone generator 130 to supply a desired level of ozone.

The ozone generated by the ozone generator 130 is provided to a mixing chamber 140 along with water supplied from a water supply 141. The ozone can be mixed in the mixing chamber 140 by venturi, by diffuser or any other suitable arrangement. The water supply 141 can be a reservoir and the water being provided to the mixing chamber 140 can pass through a filtration unit 143 that is interposed between the water supply 141 and the mixing chamber 140. It should be noted that any suitable water supply can be used.

Water from the mixing chamber 140 is supplied to the apparatus 126 by a pump 144. Preferably, the water passes through a filtration unit 146 prior to be received by the apparatus 126 and more preferably the water passes through the filtration unit 146 prior to passing through the pump 144. The pump 144 can be a peristaltic pump or any other suitable pump. In the illustrated arrangement, both the apparatus 126 and the pump 144 are controlled by the controller 120. Thus, the flow rate of the ozonated water to the apparatus 126 can be regulated to a desired flow rate, dependent upon the application.

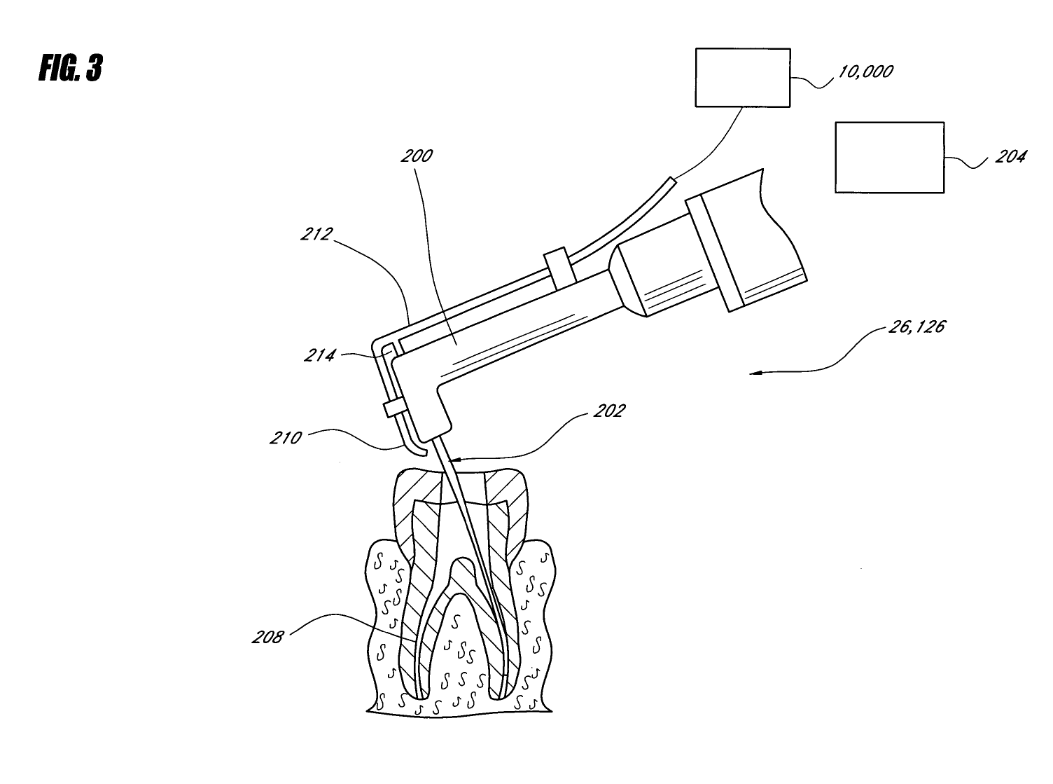

As mentioned briefly above, the apparatus 26, 126 of the above-described systems 10, 100 can comprise a handpiece 200 that is operable with a cannulated instrument 202 (see FIG. 3). Preferably, the handpiece 200 can be used to provide mechanical movement to the instrument 202. In most arrangements, the handpiece 200 provides movement or torque directly to the cannulated instrument 202. The handpiece 200 can be powered by a wide variety of commercially available power sources, such as pneumatic, hydraulic or electric motors. In some arrangements, however, manual power, such as hand motion or finger motion, for example but without limitations, can be provided to the instrument 202.

In one arrangement, the instrument 202 is coupled to a motor 204 and an ozonated water supply, such as that provided by the first and/or second system 10, 100. The motor 204 drives the instrument 202 in any of a number of desired manners. Stated another way, any suitable motion can be used. For instance, in one embodiment, the instrument 202 is rotated. In another embodiment, the instrument 202 is reciprocated up and down (e.g., piston movement). In yet another embodiment, the instrument 202 is reciprocated in alternating clockwise and counterclockwise directions. In a further embodiment, the instrument 202 is provided with sonic movement. The sonic movement can be used to vibrate or agitate materials within a tooth canal 208. Other movements, including but not limited to vibratory and ultrasonic forms of movement, also can be used. Moreover, various combinations of movement directions can be used (e.g., reciprocating up and down while alternating between clockwise and counterclockwise or reciprocating up and down while being infused with ultrasonic movement).

Most preferably, the systems 10, 100 define an irrigation system that is in fluid communication with an axial passage 300 formed within the cannulated instrument 202. The irrigation system provides ozonated fluid to wash and cool the work site during manipulation of the cannulated instrument 202. Thus, the systems 10, 100 described above supply ozonated water for use as an irrigant and/or lubricant during various dental operations.

In some arrangements, an external irrigation path 210 is provided such that ozonated water can be applied external to the instrument 202 separately from or in combination with the supply being fed through the instrument 202. The handpiece 200 preferably also has an internal or external irrigation path 212 that allows a user to apply ozonated water pumped to the handpiece 200 from a source external to the handpiece 200. The ozonated water can then flow through and/or along the cannulated instrument 202, such as a file, to a repair site. Advantageously, the ozonated water can be delivered through the cannulated file to a base of the repair site in one embodiment.

In one particular embodiment, the system can allow movement of the instrument in both rotational directions and can facilitate both irrigation and suction. In another embodiment, the system can allow a user to select the type of motion (e.g., rotational, axial, ultrasonic, etc.) depending upon preferences of the user, the technique being used and/or the procedure being performed.

The cannulated instrument 202 preferably is a dental file. In one arrangement, the file comprises a central axial flow passage 300 that extends through substantially the entire length of the file 202. The flow passage 300 is adapted to cooperate with a feeder 214 of the irrigation system that is supported by the handpiece 200, for instance. The feeder 214 can terminate within a proximal portion of the passage 300, can supply fluid that is fed into the passage 300 or can extend through substantially the entire length of the passage 300.

The file 202 preferably comprises one or more ports 302 that are disposed about its circumference just above the ultimate distal tip 304 of the file. In one arrangement, the axial flow passage 300 extends through the ultimate distal end 304 of the file. Preferably, however, the axial flow passage 300 is closed at the ultimate lower end 304 such that the risk can be reduced of pushing material forward through the apical foramen due to pressure created by the irrigation agent.

The axial flow passage desirably is in fluid communication with one or more radial port 302. In a preferred configuration, multiple radial ports are provided such that fluid, such as ozonated water, can be sprayed laterally outward in multiple directions at once. The radial ports can extend at any desired angle but preferably direct the fluid outward from a longitudinal axis of the instrument. While circular ports are shown, any suitable configuration may be used that can create such an outwardly directed dispersion or stream of irrigation fluid.

In a preferred arrangement, the dental file 202 is formed of nickel titanium tubing. Other materials, including but not limited to carbon steel, stainless steel or an acceptable alloy or composite material. While the material can be capable of being sterilized or passivated, the file 202 preferably is a one-use instrument that is disposed after use and not capable of reuse. A one-use instrument reduces the likelihood of breakage.

The tubing can be perforated and can include a latch-head configuration at the proximal end. A latch-head configuration comprises a generally I-shaped flat side that defines a step and a generally semi-circular disk above and adjacent to a generally semi-circular groove. Such a construction facilitates an interface with the selected handpiece 200. Other suitable arrangements for connecting the cannulated instrument 202 to a system designed to impart movement to the instrument also can be used. At its distal end 304, the tubing preferably has a blunt tip. In other words, the distal end 304 can be rounded in one configuration. Depending upon the application and mode of operation, an angled end or a substantially pointed tip can be used; however, the blunt end is preferred for operations where a pointed tip would unnecessarily elevate the risk of puncturing the canal wall or the apical foramen (e.g., reciprocating movement). Along the body of the instrument 202, depth markings can be provided to allow a user to determine how deeply the instrument has been inserted into the root canal. Any suitable markings can be used.

With respect to perforation, the tubing can comprise one or more openings 308, preferably many openings 308, having upstanding surfaces or lips 310, similar to a cheese grater. In some embodiments, these openings 308 define radial ports through which the irrigation fluid can flow. Other forms of suitable grinding or cutting structures also can be formed on the exterior surface of the tubing. In some arrangements, an abrasive material can be secured to at least a portion of the exterior surface of the tubing. In other arrangements, a rasp structure can be implemented. Also, various combinations of cutting geometries or features can be used depending upon various variables, such as the cutting characteristics desired (e.g., how aggressive, size of debris desired, etc.), for instance. In some arrangements, cutting features can be formed by grinding or by twisting a blank, for instance. Other suitable techniques also can be used.

It is anticipated that various sizes and shapes of files can be prepared in accordance with certain features, aspects and advantages of the present invention such that progressive steps in a dental procedure can be carried out using progressively smaller or larger cannulated instruments, depending upon the technique being employed. The tubing can have any suitable length keeping in mind a goal of creating an easily manipulated instrument. In some arrangements, the files can range in size and taper such that the distal end has a diameter less than about 1.5 mm, preferably less than about 0.5 mm and more preferably less than about 0.3 mm. In one arrangement, the files can have a distal end diameter than range in size from about 0.04 mm to about 0.4 mm. Preferably, the files have a taper of approximately 0.02 per millimeter of file length. In some embodiments, the files have a taper of between about 0.5 and about 5 degrees in at least the distal portion of the files and, in other embodiments, the files may be substantially cylindrical along the entire length of the file. Moreover, the tapering can be varied along all or a part of the length of the instrument or can be uniform along all or part of its length. In some arrangements, the taper can be formed by grinding material from a cylindrical body. Other suitable methods of forming the instrument also can be used.

The instrument 202 preferably has a size and is made of a material such that the instrument can traverse substantially the entire length of a root canal, which generally is non-linear in nature. Thus, the instrument 202 desirably has sufficient flexibility to follow the path of the canal and has sufficient rigidity and/or pushability to facilitate its use in removing material from the sidewalls of the canal 208. Moreover, the instrument 202 should have sufficient torsional rigidity to allow the instrument to be rotated, if the instrument is being used in such a mode of operation, without significant deflection or risk of breakage.

In one application, while the instrument 202 is moved in a scrubbing motion, ozonated irrigant is provided to the root canal 208. Thus, washing and scrubbing can simultaneously occur. In one arrangement, the movement of the instrument 202 (e.g., file) can be controlled at the discretion of the user such that irrigation must first begin before movement of the instrument can be initiated. Such an arrangement ensures that irrigation is being provided during all cutting in at least the final stage of the root canal procedure.

Although the present invention has been described in terms of certain embodiments, other embodiments apparent to those of ordinary skill in the art also are within the scope of this invention. Thus, various changes and modifications may be made without departing from the spirit and scope of the invention. For instance, various components may be repositioned as desired. In one arrangement, the instrument may be formed of a solid shaft having a radial groove or slit that allows the flow of fluid within the groove downward and the otherwise solid shaft may have cutting geometry formed about its exterior surface. Moreover, not all of the features, aspects and advantages are necessarily required to practice the present invention.

1. A dental apparatus comprising a handpiece and an ozonated irrigant supply system, the ozonated irrigant supply system comprising a dry air source and an ozone generator, a pump connected to the dry air source and the ozone generator and being adapted to supply air from the dry air source to the ozone generator, an ozone mixing chamber connected to the ozone generator, the ozone mixing chamber also being connected to a water source, the ozone mixing chamber introducing ozone produced by the ozone generator to the water drawn from the water source to produce ozonated water, an ozonated water supply pump fluidly connected to the ozone mixing chamber and the ozonated water supply pump being fluidly connected to the handpiece, the handpiece driving a cannulated instrument, the cannulated instrument comprising an axial flow passage and the ozonated water supply pump supplying ozonated water to the axial flow passage.

2. The apparatus of claim 1, wherein the ozonated water supply pump is fluidly connected to the ozone mixing chamber through a reservoir.

3. The apparatus of claim 1 further comprising a filtration unit positioned between the ozonated water supply pump and the mixing chamber.

4. The apparatus of claim 1, wherein the mixing chamber forms a portion of a recirculating ozonated water supply and the recirculating ozonated water supply also comprises a reservoir and a filtration unit that are fluidly connected in series with the ozone mixing chamber.

5. The apparatus of claim 4, wherein the recirculating ozonated water supply also comprising a recirculation pump that is fluidly connected in series with the ozone mixing chamber and the reservoir.

6. The apparatus of claim 1 further comprising a filtration until fluidly interposed between the water source and the mixing chamber.

7. The apparatus of claim 1, wherein the ozonated water supply pump is a peristaltic pump.

8. The apparatus of claim 1 further comprising a controller that controls a rate of air flow introduced to the ozone generator from the dry air source by controlling the pump.

9. The apparatus of claim 8, wherein the controller further controls the rate of flow of ozonated water through the ozonated water supply pump.

10. The apparatus of claim 8, wherein the controller receives an input from a foot pedal associated with the handpiece.

11. The apparatus of claim 10, wherein the controller also controls movement of the cannulated instrument induced by the handpiece.

12. The apparatus of claim 1, wherein the cannulated instrument comprises a plurality of generally radially extending ports positioned at a distal end.

13. The apparatus of claim 12, wherein the distal end of the cannulated instrument is substantially closed.

14. The apparatus of claim 1, wherein the cannulated instrument comprises one or more perforations that comprise upstanding lips.

15. The apparatus of claim 14, wherein the perforations define openings in the cannulated instrument through which ozonated water can flow from the axial passage.

16. The apparatus of claim 1, wherein the cannulated instrument is a file and said file has a distal end diameter of less than about 1.5 mm.

17. The apparatus of claim 16, wherein the distal end diameter is less than about 0.5 mm.

18. The apparatus of claim 16, wherein the file has a taper of between approximately 0.5 degrees and approximately 5 degrees per millimeter of length.

19. The apparatus of claim 1, wherein the cannulated instrument is formed from a nickel titanium material.

20. The apparatus of claim 19, wherein the cannulated instrument is formed from a nickel titanium tube.
